(19) United States
(12) Patent Application Publication
(10) Pub. No.: US 2006/0064524 A1
(43) Pub. Date: Mar. 23, 2006

(54) Rugged industrial computing module

(75) Inventor: Jackson Lum, Roslyn, NY (US)

Correspondence Address: HOFFMANN & BARON, LLP, 6900 JERICHO TURNPIKE, SYOSSET, NY, 11791, US

(73) Assignee: Logic Controls, Inc.

(21) Appl. No.: 11/244,313

(22) Filed: Oct. 5, 2005

Related U.S. Application Data
(63) Continuation-in-part of application No. 10/662,120, filed on Sep. 12, 2003.

(51) Int. Cl. G06F 13/38

(52) U.S. Cl. 710/62

(57) ABSTRACT

A rugged computing module includes a circuit board having traces associated therewith, an integrated circuit mounted on the circuit board, and an interface connector mounted proximate to an edge of the circuit board. The interface connector is electrically coupled to the integrated circuit exclusively through the traces associated therewith, thereby eliminating cable connections between the integrated circuit and the interface connector. The computing module may include a housing substantially enclosing the circuit board and restricting airflow to the integrated circuit, and a thermal transfer device thermally coupled to the integrated circuit. The thermal transfer device is adapted to transfer heat from the integrated circuit to the housing, and includes at least one of a heat sink, thermally conductive foam, and a heat pipe.

### CROSS REFERENCE TO RELATED APPLICATION

This application is a continuation-in-part of pending U.S. patent application Ser. No. 10/662,120 filed on Sep. 12, 2003, the disclosure of which is incorporated herein by reference.

### BACKGROUND OF THE INVENTION

1. Field of the Invention

The present invention relates generally to computers and more specifically relates to a compact, full feature, rugged, and reliable computing module having interfaces, memory capacity, and performance that can be used in a wide variety of industrial applications.

2. Description of the Related Art

The advances made in computers for personal, industrial, and military applications have been vast. These improvements include new and enhanced parallel, serial, and network interfaces, increased fixed and removable storage capacity; enhanced video, graphic, and audio processing; and operating systems that are substantially more powerful. However, the most notable achievements have been in providing greater processing speed and memory capacity.

Gordon Moore, a co-founder of Intel Corporation, made an observation in 1965 that the number of transistors per square inch on integrated circuits had doubled every year since the integrated circuit was invented. Moore predicted that this trend would continue for the foreseeable future. Although the rate observed by Moore has decreased since 1965, data density has doubled approximately every 18 months, and this remains the current definition of Moore's Law.

The primary driving force in the computer industry has been to maximize speed and memory capacity in any computer solution that satisfies the customer's needs, whether that customer is an individual dreaming of the ultimate system for lifelike interactive games and multimedia applications, or a corporate user trying to find a low cost solution for relatively simple control functions. As a result, the majority of computers sold today incorporate the most advanced features. Although this may well be enticing to the individual consumer who typically buys one system every four to six years, it is inappropriate and costly for the industrial user who purchases in larger quantities with the hope for a substantially longer useful life.

In addition, for many industrial dedicated applications, small but rugged computers are desirable. In most cases, computer manufacturers simply package a full-feature computer into a smaller footprint. With significantly lower sales volume, when compared with popular consumer computers, the price of these low-volume small computers become exceedingly high.

Accordingly, there remains a need in the field of computer systems for an alternative computing module tailored to requirements that are essential to industrial applications, such as factory automation, health care, patient monitoring, airline counter ticketing, tracking services, and point-of-sale (POS) terminals.

It is another goal of the present invention to provide a computing module that incorporates interfaces, memory capacity, and performance that are cost-optimized for a wide variety of industrial applications without many of the advanced features that are underutilized in such applications.

It is yet another goal of the present invention to provide an industrial computing module that is compact, lightweight, rugged, reliable, and generically applicable to the majority of industrial applications.

It is a further goal of the present invention to provide a computing module that is highly integrated to minimize the required number of peripheral components.

It is still a further goal of the present invention to provide a computing module that incorporates the minimum number of interfaces that are most utilized in industrial applications.

It is yet a further goal of the present invention to provide a computing module that includes a cost-effective central processing unit that satisfies the majority of industrial applications.

It is a further goal of the present invention to provide a computing module that substantially eliminates cable connections internal to its housing to reduce failures due to loose or faulty connections therewith.

It is yet a further goal of the present invention to provide a computing module that is substantially enclosed without airflow to the inside thereof to eliminate damage from environmental conditions, such as oil and dust, typically present in industrial applications.

### SUMMARY OF THE INVENTION

The foregoing needs, purposes, and goals are satisfied in accordance with the present invention that, in one embodiment, provides a rugged computing module with a circuit board having traces associated therewith, an integrated circuit mounted on the circuit board, and an interface connector mounted proximate to an edge of the circuit board. The interface connector is electrically coupled to the integrated circuit exclusively through the traces associated therewith, thereby eliminating cable connections between the integrated circuit and the interface connector.

The computing module also includes a housing substantially enclosing the computing module and restricting airflow to the integrated circuit. The housing is adapted to be used as a heat sink for the integrated circuit, and may have grooves on an external surface thereof. The integrated circuit includes at least one of a microcontroller, microprocessor, digital signal processor (DSP), application specific integrated circuit (ASIC), and gate array. The circuit board may include multiple layers, and the computing module may include a heat sink, thermally conductive foam, and/or a heat pipe thermally coupled to the integrated circuit.

In another embodiment, the present invention provides a rugged computing module, which includes a circuit board having traces associated therewith, an integrated circuit mounted on the circuit board, a housing substantially enclosing the circuit board and restricting airflow to the integrated circuit, and a thermal transfer device thermally coupled to the integrated circuit. The thermal transfer device is adapted to transfer heat from the integrated circuit to the housing, and includes at least one of a heat sink, thermally conductive foam, and a heat pipe.

These and other purposes, goals and advantages of the present invention will become apparent from the following detailed description of illustrative embodiments thereof, which is to be read in connection with the accompanying drawings.

### BRIEF DESCRIPTION OF THE DRAWINGS

FIG. 1 is a top perspective view of the computing module formed in accordance with the present invention.

FIG. 2 is a front view of the computing module formed in accordance with the present invention.

FIG. 3 is a rear view of the computing module formed in accordance with the present invention.

FIG. 4 is a functional block diagram of the computing module formed in accordance with the present invention.

FIG. 5 is an internal view of an alternative embodiment of the computing module.

FIGS. 6A and 6B are front and rear perspective external views, respectively, of the alternative embodiment of the computing module shown in FIG. 5.

FIG. 7 is a side external view of the alternative embodiment of the computing module shown in FIG. 5

FIGS. 8A, 8B, and 8C are pictorial views of a heat pipe, heat sink, and heat conducting foam, respectively, preferably used in the computing module shown in FIG. 5.

### DETAILED DESCRIPTION OF THE PREFERRED EMBODIMENTS

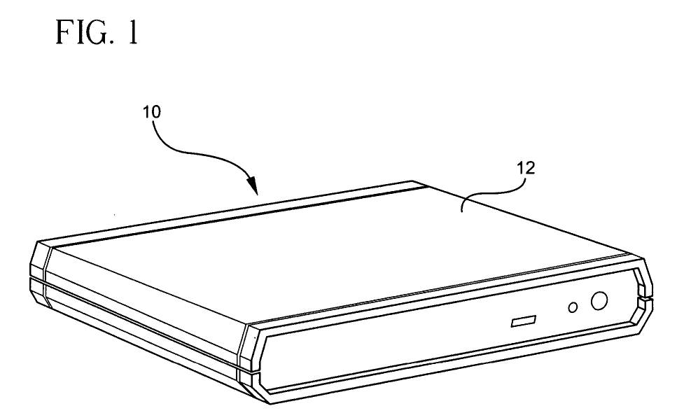

In accordance with the preferred embodiments contemplated as being within the scope of the present invention, FIG. 1 is a top perspective view of a computing module 10. The computing module 10 includes an external housing 12, which is preferably die cast from zinc and substantially restricts airflow to circuitry within the housing 12. The housing 12 is preferably used as a heat sink for the computing module 10. If the surface area of the housing 12 is expressed in square units, such as X in², and the volume of the housing is expressed in cubic units, Y in³, then X is preferably greater than Y.

The housing 12 is preferably about 6.3 inches in width, 1.0 inch in height, and 5.1 inches in depth. The weight of the computing module 10 is about 2.15 pounds and the operating temperature is preferably about 5° C. to 40° C. with a storage temperature of about 0° C. to 60° C. Two mounting brackets (not shown) are preferably provided on the bottom of the housing 12 so that the computing module 10 may be mounted to a wall, ceiling, tabletop, counter, and the like. It is to be understood that the physical characteristics of the computing module are not critical, are merely provided as an example, and are not intended to limit the scope of the present invention in any manner.

The computing module 10 preferably includes components that are mounted on a single printed circuit board (PCB) within the external housing 12 with no moving mechanical parts, such as a fan or a disk drive. Flash memory is preferably used as a substitute for hard drive storage area.

The computing module 10 formed in accordance with the present invention preferably includes an Intel® compatible x86-based microcontroller, which is Windows® compatible and able to run Linux® based applications. The microcontroller is preferably provided with a clock that satisfies a minimum requirement of an application to reduce heat dissipation and cost. It is anticipated that the computing module 10 would be suitable for use in a wide variety of industrial applications, such as restaurant kitchen systems, point of sale (POS) systems, work stations, automatic identification systems, airline counter ticketing, tracking services, factory automation, healthcare and patient monitoring systems, and the like.

The computing module 10 also preferably provides interface capabilities, such as an Ethernet port, a Universal Serial Bus (USB) port, serial (RS-232) ports, a PS/2 keyboard/mouse port, and an SVGA (super video graphics array) port. Additional wired and wireless interface capabilities, such as infrared and Bluetooth, are contemplated to be within the scope of the present invention. The Ethernet port permits full access to the Internet, file transfer, and system networking resources. The USB port enables the computing module 10 to drive multiple peripheral devices and host a wide variety of application software.

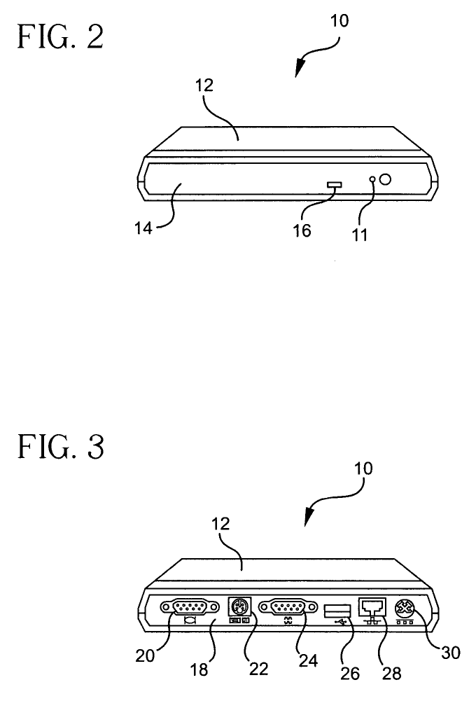

FIG. 2 is a front view of the computing module 10 formed in accordance with the present invention. The computing module 10 includes a front panel 14, through which a power light emitting diode (LED) 16 is disposed. The power LED 16 preferably indicates whether the computing module 10 is powered and operational. A reset switch on the printed circuit board is accessible through an aperture 11 in the housing 12 by using commonly objects, such as a ballpoint pen.

A rear view of the computing module 10 is shown in FIG. 3. The computing module 10 includes a rear panel 18, through which various interface connectors are disposed. The interface connectors preferably include an SVGA port connector 20, a PS/2 keyboard/mouse port connector 22, a serial port connector 24, a USB port connector 26, an Ethernet port connector 28, and a power adapter connector 30.

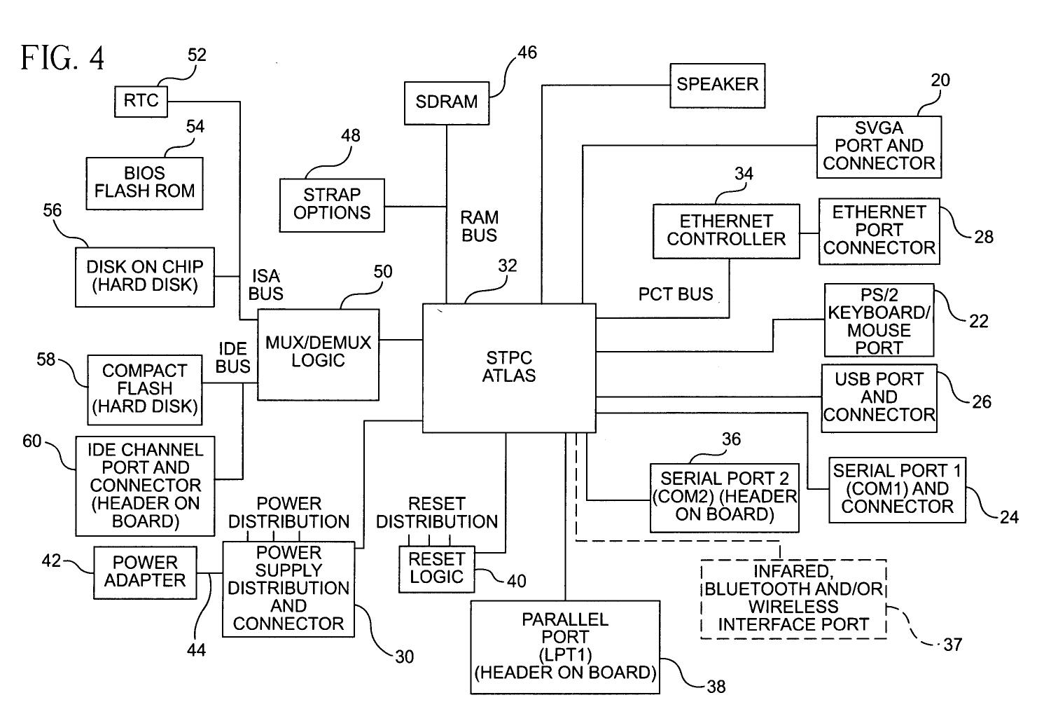

FIG. 4 is a block diagram of a preferred circuit implementation of the computing module 10 shown in FIGS. 1-3. The circuitry preferably includes an STPC12HEYC microcontroller 32 operating at 133 MHz, which is a 516-pin ball grid array (BGA) package that is commercially available from ST Microelectronics, 1000 East Bell Road, Phoenix, Ariz. 85022. The microcontroller 32 is operatively coupled to an STE10/100A Ethernet controller 34 and HB626-1 Ethernet magnetics, which are also commercially available from ST Microelectronics. The Ethernet controller 34 is operatively coupled to the Ethernet port connector 28.

The microcontroller 32 preferably also interfaces with the SVGA port and connector 20, PS/2 keyboard/mouse port and connector 22, USB port and connector 26, and the serial port and connector 24, the ports of which are shown in FIG. 3. The SVGA port preferably supports 1280×1024 pixels with 4 MB of video ram that supports up to 16 million colors. The microcontroller 32 preferably interfaces with the Ethernet controller 34 through a peripheral component interconnect (PCI) bus.

The microcontroller 32 also preferably interfaces to an auxiliary serial port 36, an auxiliary parallel port 38, and an integrated development environment (IDE) channel port and connector 60. Access to these ports is preferably provided by headers on the printed circuit board. Additional wireless interface ports 37, such as Infrared (IR) and Bluetooth Reset may also be included in the computing module. Reset logic 40, which is operatively coupled to and controlled by the microcontroller 32, preferably provides a suitable reset signal for various portions of the computing module circuitry.

The microcontroller 32 is also operatively coupled to a power supply distribution and connector assembly 30, which preferably inputs various direct current (dc) supply voltages from the power supply connector 30 located on the rear panel 18 of the computing module 10 shown in FIG. 3. Voltage converters and regulators are preferably located in a power adaptor 42, which is coupled to the power supply distribution and connector assembly 30. The power adapter 42 is preferably located external to the housing 12 and coupled to the power supply distribution and connector assembly 30 through a power cord 44.

As shown in FIG. 4, the computing module circuitry preferably includes synchronous dynamic random access memory (SDRAM) 46, which is operatively coupled to the microcontroller 32. The SDRAM 46 may be implemented using IS42S16400A-10T/7T 1M×16×4 SDRAM devices, which are commercially available from Integrated Silicon Solution, Inc. located at 2231 Lawson Lane, Santa Clara, Calif. 95054. The computing module 10 preferably supports about 32 MB to 128 MB of SDRAM.

Various hardware programmable features are preferably selected by manipulation of jumpers in a strap options 48 circuit, which is operatively coupled to the microcontroller 32. The remaining devices shown in FIG. 4, which are preferably accessed by the microcontroller 32 through multiplexor/demultiplexor logic circuitry 50, include a real time clock 52, a BIOS flash ROM 54, a Disk-on-Chip 56, compact flash 58, and an Integrated Development Environment (IDE) channel port and connector 60. The logic circuit 50 preferably provides address, data, and control interfaces between the microcontroller 32, peripheral devices, and memory.

The real time clock 52 is preferably implemented with an M48T86MH device, which is commercially available from ST Microelectronics. The BIOS flash ROM 54 is preferably implemented using AT49F002N70JC devices, which are commercially available from Atmel Corporation located at 2325 Orchid Park Way, San Jose, Calif. 95131, or SST39SF020A devices, which are commercially available from SST located at 1171 Sonora Court, Sunnyvale, Calif. 94086.

The Disk-on-Chip flash memory 56 is preferably implemented with a Disk-on-Chip 2000, which is commercially available from M-Systems, Inc. located at 8371 Central Avenue, Suite A, Newark, Calif. 94560. The Disk-on-Chip 56 provides a solid-state alternative to hard drive storage areas to increase reliability by eliminating moving parts in the computing module 10. The Disk-on-Chip 56 and the compact flash 58 provide a solid-state storage area of about 16 MB to more than 4 GB and are preferably selected to satisfy a minimum requirement of the intended application. However, since it is contemplated that the density of memory, such as that provided by flash memory, will increase dramatically in the future in accordance with technological advances, all memory capacities set forth herein are merely intended as an example without limiting the scope of the present invention in any manner.

The real time clock 52, BIOS flash ROM 54, and Disk-on-Chip 56 are preferably accessed through an industry standard architecture (ISA) bus coupled to the microcontroller 32 through the logic circuit 50. The compact flash 58 is preferably implemented by a THNCFxxx MBA compact flash card, which is commercially available from Toshiba America Electronic Components, Inc. located at 2035 Lincoln Highway, Suite 3000, Edison, N.J. 08817. Both the compact flash 58 and IDE channel port and connector 60 are preferably coupled by an integrated development environment (IDE) bus to the microcontroller 32 through the logic circuit 50. The IDE channel port and connector 60 preferably provide the microcontroller 32 with access to an external hard drive storage area through a header or connector on the printed circuit board.

The SVGA port connector is preferably implemented with a DB15 female connector. The PS/2 keyboard/mouse port connector is preferably a mini-DIN6 female connector. The serial port connector is preferably a DB9 male connector. The USB port connector is preferably a standard USB type B connector. The Ethernet port is preferably an RJ45 8-pin female connector, and the power supply connector is preferably a shielded snap lock mini-DIN with EMI/RFI suppression female connector.

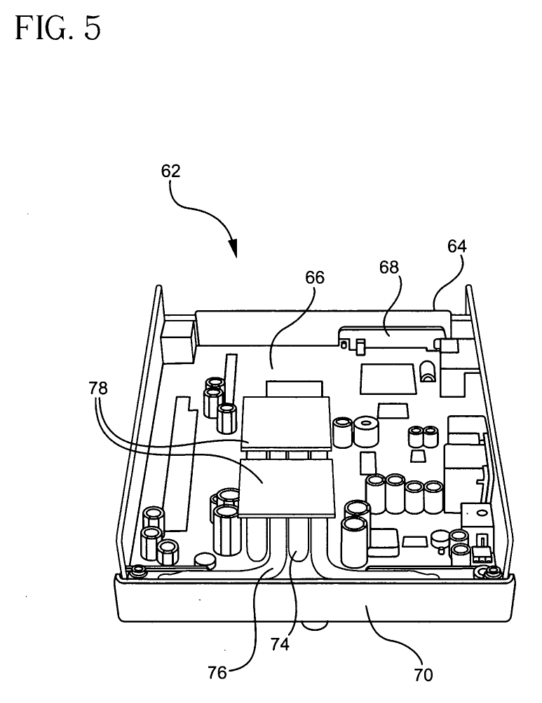

An internal view of an alternative embodiment of the computing module 62 is shown in FIG. 5. In addition to the features described above, embodiments of the present invention preferably incorporate one or more of the following features:
1. a lack of or a minimized quantity of cable connections inside the external housing 70;
2. a reduction in the size of the footprint to enable placement of the computing module 62 in locations where space is critical;
3. a rugged construction with a durable case or external housing 70;
4. a large quantity of input/output (IO) ports to support a large quantity of peripheral devices; and
5. a fanless operation.

Reducing the number of internal cable connections substantially avoids a common problem of loose or faulty connections, which is a major source of computer failure. To avoid the use of internal cable connections, substantially all connectors in the computing module of the present invention are preferably mounted at an edge 64 of the printed circuit board 66, as shown in FIG. 5. This placement alleviates the need for making connections from points within an outer perimeter of the printed circuit board 66 to points external to the computing module 62, such as those made through a connector or connector panel 68. Cable connections are defined herein to include wires, cables, and the like that may be used to electrically connect two or more points, but excludes lands or traces on printed or multilayer circuit boards.

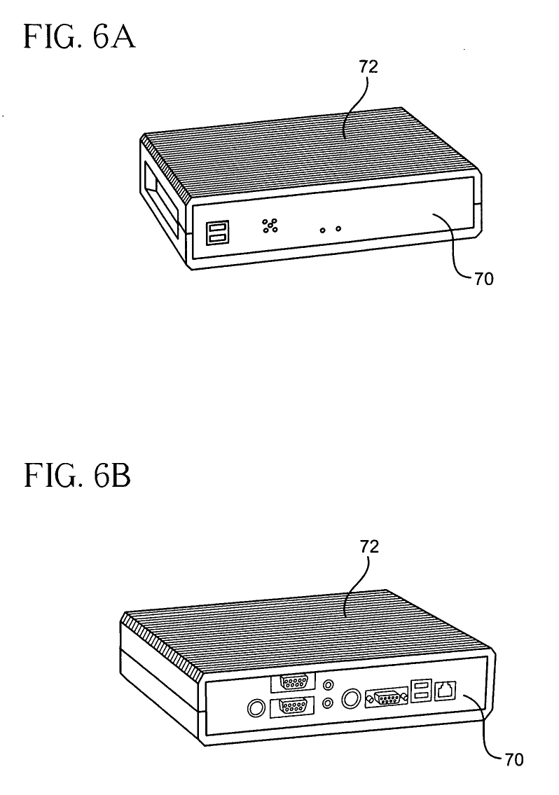

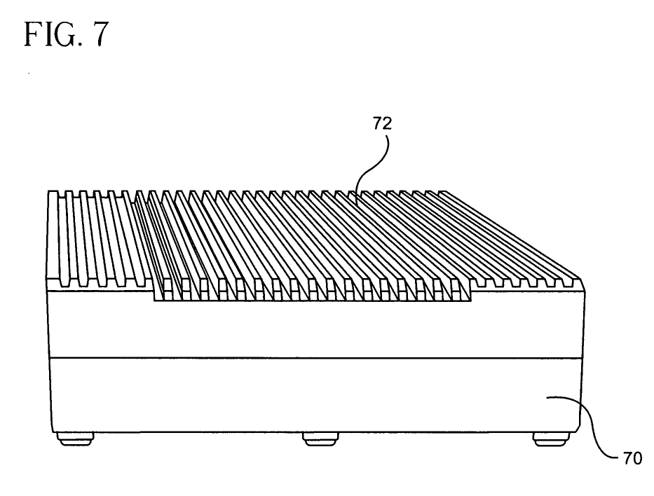

To achieve a small footprint, the printed circuit board 66 is preferably manufactured as a multi-layer board, for example having eight (8) or more layers, with a high component density layout, as shown in FIG. 1. To achieve a rugged construction, the external housing 70, as shown in FIGS. 6a, 6b, and 7, is preferably die cast and incorporates grooves for heat transfer and improved rigidity. As shown in FIGS. 1, 6A, and 6B, the computing module 62 preferably includes a large quantity of connectors, such as, but not limited to RS-232, USB, and/or GPIB connectors, and the like known in the art.

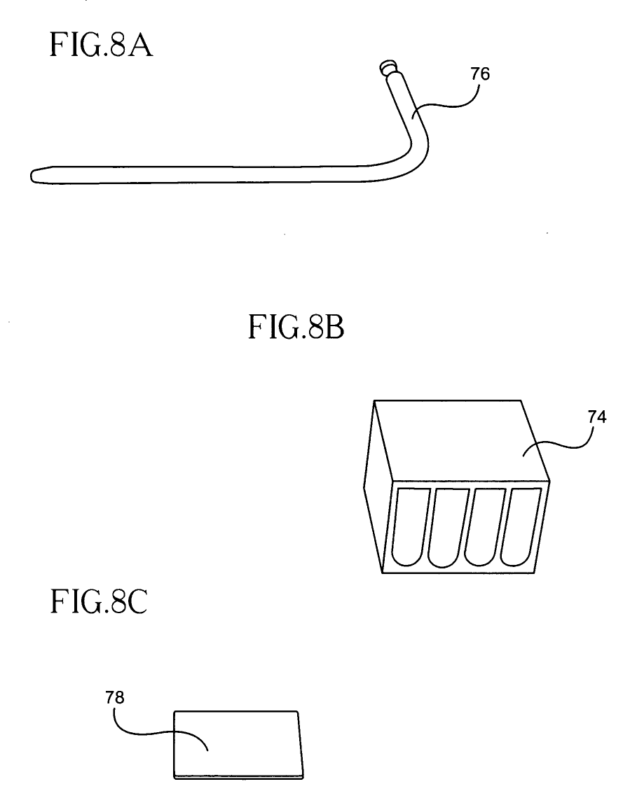

Industrial computers are preferably capable of operating in an oily or dusty environment. Thus, the commonly used internal fan is not acceptable since it draws oil or dust into the computer and causes failure. To achieve fanless operation in the computing module 62 of the present invention, thermal techniques are preferably used that include one or more of the following:
1. manufacturing the external housing to incorporate grooves, as shown in FIGS. 6A, 6B, and 7, which substantially increases the effective surface area that can be used to radiate heat to the environment;
2. using heat sinks 74, such as that shown in FIGS. 5 and 8 with partially enclosed chambers that are open at the ends of the heat sink, specifically designed for the efficient transfer of heat from the hot chip set integrated circuit (IC), such as but not limited to that used for the central processing unit (CPU), to heat pipes 76, as well as using heat conducting foam 78, as shown in FIGS. 5 and 8;
3. using heat pipes 76 to transfer heat from the heat sinks 74 to the external housing 70, as shown in FIG. 5; and
4. using heat conducting foam 78 to transfer heat from the heat sink 74 to the external housing 70, as shown in FIG. 5.

A heat pipe is a device that can quickly transfer heat from one point to another. Heat pipes are often referred to as “superconductors” of heat since they possess an extraordinary heat transfer capacity and rate with almost no heat loss.

Heat pipes preferably include a sealed aluminum or cooper container whose inner surfaces have a capillary wicking material. A heat pipe is similar to a thermosyphon. However, heat pipes differ from a thermosyphons by virtue of their ability to transport heat against the gravitational forces present in an evaporation-condensation cycle with the help of porous capillaries that form a wick. The wick provides the capillary driving force to return the condensate to the evaporator. The quality and type of wick usually determines the performance of the heat pipe. Different types of wicks are used depending on the application for which the heat pipe is being used.

It is to be understood that the microcontroller described above can also be implemented using any computing device or set of devices, such as a microprocessor, digital signal processor (DSP), application specific integrated circuit (ASIC), gate array, and the like while remaining within the scope of the present invention.

Therefore, a rugged computing module formed in accordance with the present invention is tailored to requirements that are essential to industrial applications, such as factory automation, health care, patient monitoring, and airline counter ticketing. The computing module incorporates interfaces, memory capacity, and performance that are cost-optimized for a wide variety of industrial applications without many of the advanced features that are underutilized in such applications.

The rugged computing module also substantially eliminates cable connections internal to its housing to reduce failures due to loose or faulty connections therewith. Further, the computing module is substantially enclosed without airflow to the inside thereof to eliminate damage from environmental conditions, such as oil and dust, typically present in industrial applications.

Although illustrative embodiments of the present invention have been described herein with reference to the accompanying drawings, it is to be understood that the invention is not limited to those precise embodiments, and that various other changes and modifications may be provided therein by one skilled in the art without departing from the scope or spirit of the invention.

What is claimed is:

1. A rugged computing module comprising:
a circuit board comprising traces associated therewith;
an integrated circuit mounted on the circuit board; and
an interface connector mounted proximate to an edge of the circuit board, the interface connector being electrically coupled to the integrated circuit exclusively through the traces associated therewith, thereby eliminating cable connections between the integrated circuit and the interface connector.

2. A rugged computing module as defined by claim 1, wherein the interface connector comprises at least one of an Ethernet connector, a Universal Serial Bus (USB) connector, a serial connector, a parallel connector, a keyboard/mouse connector, a Super Video Graphics Array (SVGA) connector, an Infrared (IR) connector, a Bluetooth connector, and a wireless port connector.

3. A rugged computing module as defined by claim 1, further comprising a housing substantially enclosing the computing module, the housing substantially restricting airflow to the integrated circuit.

4. A rugged computing module as defined by claim 3, wherein the housing is adapted to be used as a heat sink for the integrated circuit.

5. A rugged computing module as defined by claim 3, wherein the housing comprises grooves on an external surface thereof.

6. A rugged computing module as defined by claim 1, wherein the integrated circuit includes at least one of a microcontroller, microprocessor, digital signal processor (DSP), application specific integrated circuit (ASIC), and gate array.

7. A rugged computing module as defined by claim 1, wherein the circuit board comprises multiple layers.

8. A rugged computing module as defined by claim 1, further comprising a heat sink thermally coupled to the integrated circuit.

9. A rugged computing module as defined by claim 8, wherein the heat sink comprises a plurality of partially enclosed chambers.

10. A rugged computing module as defined by claim 1, further comprising heat conducting foam thermally coupled to the integrated circuit.

11. A rugged computing module as defined by claim 1, further comprising a heat pipe thermally coupled to the integrated circuit.

12. A rugged computing module comprising:
a circuit board comprising traces associated therewith;
an integrated circuit mounted on the circuit board;
a housing substantially enclosing the circuit board and integrated circuit; the housing substantially restricting airflow to the integrated circuit; and
a thermal transfer device thermally coupled to the integrated circuit, the thermal transfer device being adapted to transfer heat from the integrated circuit to the housing, the thermal transfer device comprising at least one of a heat sink, thermally conductive foam, and a heat pipe.

13. A rugged computing module as defined by claim 12, further comprising an interface connector mounted proximate to an edge of the circuit board, the interface connector being electrically coupled to the integrated circuit exclusively through the traces associated therewith, thereby eliminating cable connections between the integrated circuit and the interface connector.

14. A rugged computing module as defined by claim 13, wherein the interface connector comprises at least one of an Ethernet connector, a Universal Serial Bus (USB) connector, a serial connector, a parallel connector, a keyboard/mouse connector, a Super Video Graphics Array (SVGA) connector, an Infrared (IR) connector, a Bluetooth connector, and a wireless port connector.

15. A rugged computing module as defined by claim 12, wherein the housing is adapted to be used as a heat sink for the integrated circuit.

16. A rugged computing module as defined by claim 12, wherein the housing comprises grooves on an external surface thereof.

17. A rugged computing module as defined by claim 12, wherein the integrated circuit includes at least one of a microcontroller, microprocessor, digital signal processor (DSP), application specific integrated circuit (ASIC), and gate array.

18. A rugged computing module as defined by claim 12, wherein the circuit board comprises multiple layers.

19. A rugged computing module as defined by claim 12, wherein the heat sink comprises a plurality of partially enclosed chambers.
